(19) United States
(12) Patent Application Publication
(10) Pub. No.: US 2012/0092163 A1
(43) Pub. Date: Apr. 19, 2012

(54) INTRUDER DETECTION AND INTERDICTION SYSTEM AND METHODS FOR USING THE SAME

(76) Inventor: Joseph N. Hart, Alexandria, VA (US)

(21) Appl. No.: 13/087,158

(22) Filed: Apr. 14, 2011

Related U.S. Application Data
(60) Provisional application No. 61/324,051, filed on Apr. 14, 2010.

(51) Int. Cl. G08B 13/00

(52) U.S. Cl. 340/541

(57) ABSTRACT

Intruder detection and interdiction system and method for using the same. An intruder detection system comprises sensor devices, countermeasure devices, and a control unit connected to the sensor and countermeasure devices. Sensor devices include voice recognition components. The system may detect intruders with the sensor devices, query for identification by a verbal response to be checked by the voice recognition components and activate countermeasure devices if there is no response or if the response is not an authorized voice. In further embodiments, the control unit may be connected to a network or a phone line. Further embodiments comprise a transportable alert device connected to the control unit.

### CROSS-REFERENCE TO RELATED APPLICATION

This application claims the benefit of priority to U.S. Provisional Patent Application Ser. No. 61/324,051 filed Apr. 14, 2010, which is hereby incorporated herein by reference in its entirety.

### BACKGROUND

Home security systems are designed to alert the user upon detection of danger in the home. Each system may be designed to detect a single danger, such as fire, smoke, or intrusion, or any combination of dangers. These security systems monitor for any such danger with various interconnected devices spread throughout the home that can report a detected danger to a control unit. Devices in a home security system may include smoke or heat detectors, motion sensors, carbon monoxide detectors, sensors to indicate the opening of a door or window, and many others depending upon the system's design. Upon receiving a report from one of the devices, the control unit can respond by alerting the home owner, sounding an alarm, or even contacting a connected party, such as the police, the fire department, the security company responsible for the security system, or any other party.

A typical home security system will utilize a star or bus topology or a wireless network to interconnect the control unit, a keypad for user input, and the various sensor devices. These systems are often connected to the security company that installed the system either through a phone line, via a network (such as the internet), or both. The security company can monitor the system via this connection and respond to any detected dangers personally or by contacting the home owner or the proper authorities.

Home security systems offer a variety of benefits including deterrence of thieves, personal safety, reduced insurance premiums, and peace of mind. These benefits, in conjunction with an increase in affordability, have recently contributed to a rise in home security system popularity.

### SUMMARY

Embodiments are directed to a security system and method for detecting and interdicting intruders in a structure which may be, for example but without limitation, a home, a commercial building or other structure. The system comprises sensor devices, countermeasure devices, and a control unit connected to the sensor and countermeasure devices. In further embodiments, the control unit may be connected to a network (such as the internet, a fiber optic network, a hybrid-fiber-cable network, or a wireless network) or to a phone line. Further embodiments comprise a transportable alert device in a communication control unit.

Embodiments are directed to a home or commercial building (collectively a “structure”) security system capable of detecting and interdicting intruders. In other embodiments areas outside of a structure may be monitored. Both the structure and the area outside the structure may be divided into zones that may be assigned rules that determine how the security system responds to data from the sensor devices.

The embodiments may rely on a variety of interconnected sensor devices and control systems, voice recognition technology for identifying persons authorized to be present, and countermeasures which are employed in a tiered response (least severe to most severe) to deter activities of unauthorized intruders.

Embodiments may comprise numerous types of sensor devices as well as multiple devices of each type spread throughout the home. Sensor devices of embodiments may include, but are not limited to, motion sensors, sensors designed to recognize the sound of broken glass, cameras, infrared sensors, noise detectors, microwave detectors, ultrasonic detectors, photoelectric beam sensors, voice recognition sensors, a digital camera coupled to facial recognition software, a retinal scanner, an infrared scanner and biometric scanner, presence detectors, and sensors to indicate the opening of a door or window. Each of these devices can be employed in one or more rooms or in every room.

Sensor devices in an embodiment may be connected to a control unit. This connection may be accomplished via a direct connection from a particular sensor to the control unit or via a network over which one or more of the sensors communicate to the control unit. The network can be any type of wired or wireless architecture. The control unit may then perform a variety of tasks, such as relaying a device's communication to the user or to an outside receiver, such as a security company or the police.

In an embodiment, the security system may include a transportable alert and control device. In an embodiment, the transportable alert device may be an interface through which the user may check or update the security system's status, turn the system on and off, and monitor alerts. It may be used to display a schematic of the home and indicate which sensor devices or countermeasures are active. It may also indicate the number and location of intruders and/or people present in a particular space. The transportable alert device could have various forms including a laptop computer, a watch, or a mobile device, such as a cellular phone or PDA.

### DESCRIPTION OF THE DRAWINGS

FIG. 1 is a block diagram illustrating a security system according to an embodiment.

FIG. 2 is a process flow diagram of a method for detecting and interdicting intruders according to an embodiment.

FIG. 3 is a block diagram illustrating a security system applied to a structure and an area outside the structure according to an embodiment.

FIG. 4 is a block diagram illustrating the components of a computing device.

FIG. 5 is a block diagram illustrating the components of a server device.

### DETAILED DESCRIPTION

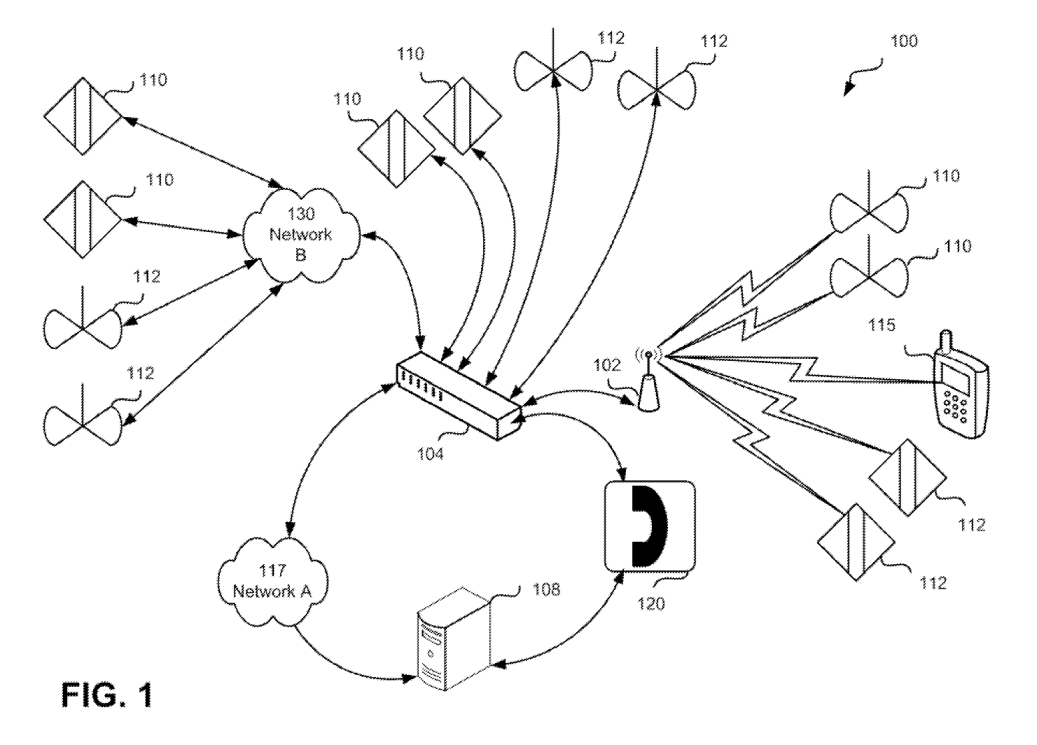

FIG. 1 illustrates a block diagram of a security system 100 according to an embodiment. A control unit 104 is connected to sensor devices 110, countermeasure devices 112, and a transportable alert device 115. In an embodiment, the connection between the control unit 104 and the sensor devices 110, the countermeasure devices 112, and the transportable alert device 115 is accomplished using a transceiver or wireless network access point 102 is illustrated in system 100. While the access point 102 and control unit 104 are illustrated as discrete components, this is not meant as a limitation. The access point 102 and the control unit 104 may be integrated into a single device. FIG. 1 further illustrates that the sensor devices 110, countermeasure devices 112, and the transportable alert device 115 may communicate with the control unit 104 via a direct connection or via a network B 130.

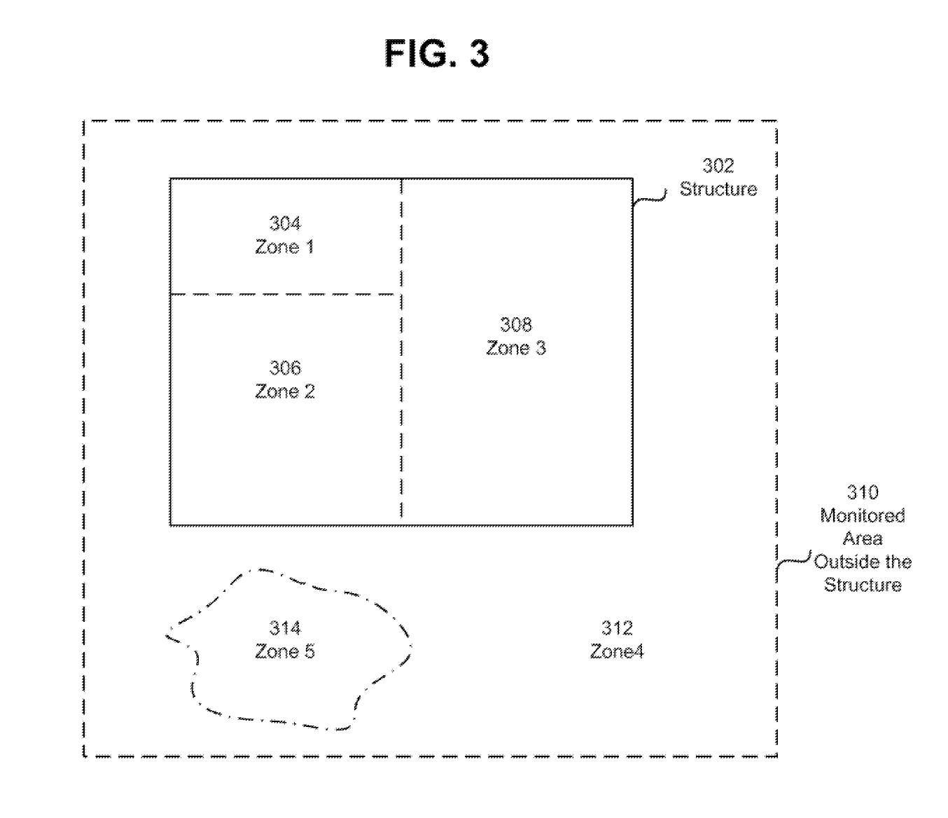

In an embodiment, the control unit may be implemented on a computing device as illustrated in FIG. 3.

Sensor devices 110, countermeasure devices 112, and a transportable alert device 115 may exchange signals with the control unit 104. Sensor devices 110 may include, but are not limited to, motion sensors, sensors designed to recognize the sound of broken glass, cameras, infrared sensors, noise detectors, microwave detectors, ultrasonic detectors, photoelectric beam sensors, voice recognition sensors, a digital camera coupled to facial recognition software, a retinal scanner, an infrared scanner and biometric scanner, presence detectors, and sensors to indicate the opening of a door or window. Each of these devices can be employed in one or more rooms or in every room.

In an embodiment, the sensor device 110 may further comprise audio transducer devices, such as microphones, to detect sound in each room. The audio transducer devices may be used for detecting intruders in a manner similar to the audio-based sensor devices discussed above but may also be used for receiving verbal commands from a registered voice. The audio transducer devices may be coupled with voice recognition software and a database of registered voices (sometime collectively referred to as “voice recognition components”) to be recognized. The voice recognition software and database can be stored and processed locally with the device or remotely on the network. Because of differing acoustics in each room of the home, the database may include multiple fields for each registered voice based on location, or there may be separate databases for each location.

The security system may further comprise speakers for use with the previously described voice recognition components. Thus, people present may speak and be understood by the security system via the voice recognition components and the system could respond with audio messages via the speakers. This back and forth may allow the security system to query the people present for identity and recognize them as intruders or registered voices. It could also allow registered voices to adjust the settings of the security system with verbal commands.

There may be any number of sensor devices 110, countermeasure devices 112, and transportable alert devices 115 in the security system 100. The sensor devices 110, countermeasure devices 112, and transportable alert devices may be any of the various types previously discussed. In an embodiment, the illustrated sensor devices 110 may be dedicated microphones that may be used to provide voice recognition functionality.

The control unit 104 may issue commands and receive communication from sensor devices 110, countermeasure devices 112, and the transportable alert device 115 via the access point 102, or if the access point 102 is not used, via the means used to connect the sensor devices 110, countermeasure devices 112, and the transportable alert device 115 to the control unit 104.

The transportable alert device 115 can also communicate and send commands to the control unit 104 via the access point 102, and thereby control the entire security system 100. In an embodiment, the transportable alert device 115 communicates with the access point 102 via a wireless protocol such as WiFi or Bluetooth.

The control unit 104 may be connected to a network A 117, such as the internet, a fiber network or a hybrid-fiber-cable network, internet or a phone line 120. Therefore, if the transportable alert device 115 has a phone or internet connection, it may also be able to communicate with the control unit 104 via these connections. The control unit 104 can communicate a monitoring device 108, such as a security company, the fire department, or the police, via the network A 117 or phone 120. This may allow the operator of the monitoring device 108 to monitor or to receive alert signals from the system 100.

In an embodiment, the monitoring device 108 stores all data generated by the security system 100. In another embodiment, the monitoring device 108 stores all data generated by the security system relative to an event.

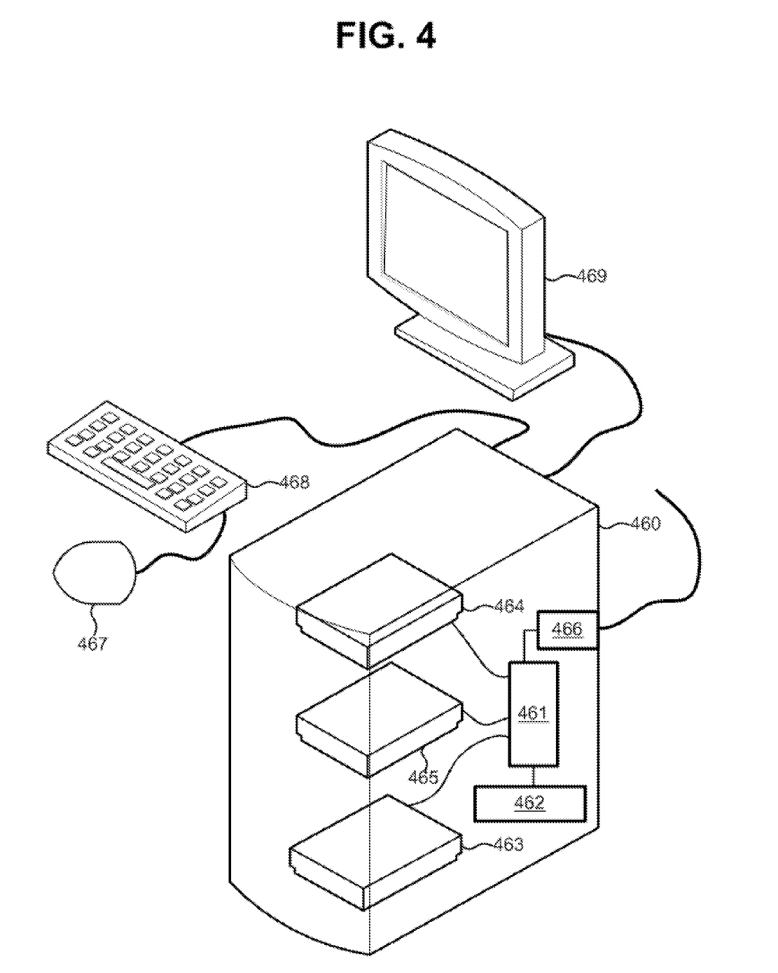

In an embodiment, the monitoring device 108 may be implemented on a computing device or a server device as illustrated in FIGS. 3 and 4.

The sensors and countermeasure devices can be distributed among the rooms of a home, office, or other structure although not all rooms may have the same devices.

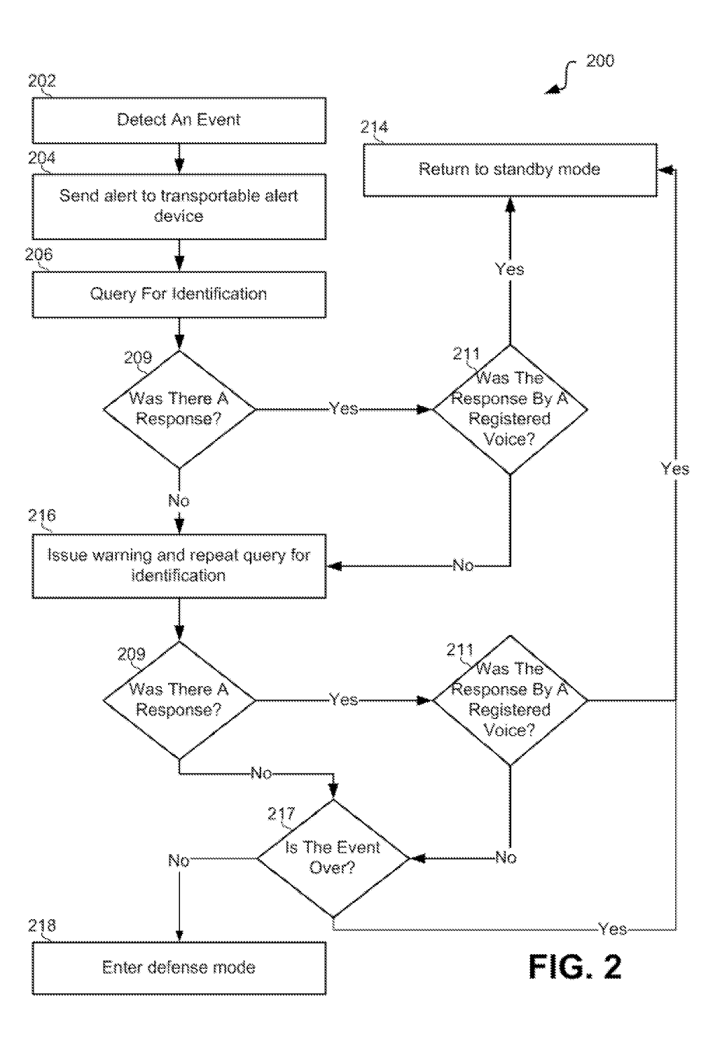

FIG. 2 illustrates an embodiment method 200. The security system 100 may detect a sensor event, block 202, such as a door opening, glass breaking, movement within the structure, a sound, the presence of a person in a part of the structure or any other sensor event that may be detected by one or more sensor devices 110. The security system 100 may be configured by the user so that the user may select or deselect whether a certain sensor event rises to the level of an alert event or which sensors are active in which rooms for which purpose. The security system 100 may send an alert to the transportable alert device 115 when it is determined that a sensor event has risen to the level of an alert event, block 204. The security system 100 may also send alerts to the transportable alert device 115 at any time, provide alert reports in response to a request from the transportable alert device 115, or even remain in constant communication providing continuous updates of the status of the security system 100.

At block 206, the security system 100 may query for verbal identification. This query may take the form of a message played over speakers or sent to the transportable alert device 115, or it could be a visual display such as flashing lights or any other indication.

The security system 100 may then determine whether there was a response to the query, determination block 209. If there is a response (i.e., the determination at block 209=“Yes”), the security system 100 could determine whether the response belonged to a registered voice by using voice recognition components, determination block 211. If the response did belong to a registered voice (i.e., the determination at block 211=“Yes”), the security system 100 could return to whichever standby mode it was in prior to detecting the sensor event at block 202. If the response was not identified as belonging to a registered voice (i.e., determination at block 211=“No) or if there was no response at all (i.e., determination at block 209=“No”), the security system 100 could determine that an alert event had occurred, issue a warning about potential countermeasures and repeat the query for identification, block 216. After the repeated query at block 216, the system could again determine whether there was a response, determination block 209, and if there was a response, whether the response was by a registered voice, determination block 211. If there was a response (i.e., determination at block 209=“Yes”) and the response was by a registered voice (i.e., determination at block 211=“Yes”), the security system 100 may cancel the alert event and return to standby mode, block 214. If there was no response (i.e., determination at block 209=“No”) or the response was not by a registered voice (i.e., determination at block 211=“No”), the security system 100 may determine whether the alert event is still taking place, determination block 217. The alert event would be considered still taking place if the sensor devices 110 were still detecting a sensor event, such as if an intruder was still present If the intruder has fled and the alert event is over (i.e., determination at block 217=“Yes”), then the system may return to a standby mode, block 214. However, if the alert event is still in progress (i.e., determination at block 217=“No”), the system will enter a defense mode, block 218. A defense mode may involve activating one or more countermeasure devices 112 in the area of the detected alert event or against an intruder detected by a sensor device 110.

The security system 100 may utilize a variety of graduated countermeasures. These countermeasures can include warnings from speakers to the user and to the intruder, loud noise creation, gases such as mace or pepper spray that irritate or incapacitate or scent based gases to drive the intruder out, water or foam sprays, and other legal self defense mechanisms.

Countermeasures may be employed when an intruder is detected. If a sensor device detects a presence and does not receive a command in a voice registered with the voice recognition software and database, the presence can be considered an intruder and the control unit can activate one or more countermeasures. Embodiments can begin with a single, less potent countermeasure and shift to another or multiple countermeasures if the intruder's presence continues to be detected. In an embodiment, the security system determines a number of people present in a particular space and requires an equal number of acknowledgements from registered voices in order to clear an alarm.

FIG. 3 is a block diagram illustrating a security system applied to a structure and an area outside the structure according to an embodiment.

In this embodiment, a structure and an area outside the structure are monitored. Both the structure and the area outside the structure may be divided into zones. A zone may be assigned rules that determine how the security system responds to data from the sensor devices located in that zone.

A structure 302 is divided into zones, such as zone 1 304, zone 2 306, and zone 3 308. While three zones have been illustrated for clarity, the structure 302 may be divided into additional zones. Similarly, an area outside of the structure may be divided into zones, such as zones 4 312 and 5 314.

The security system 100 (see FIG. 1) monitors each zone of the structure 302 and each zone of the outside area 310 as previously described. In an embodiment, the sensor devices 110 and the countermeasure devices 112 are selected for each zone in accordance with security factors associated with each zone. In addition, the control unit 104 may apply rules that are based on the security factors associated with each of the zones 1, 2 and 3.

By way of illustration and not by way of limitation, zone 1 304 may be a living area while zone 2 306 may be an area where valuables are stored. Zone 3 308 may be an area where hazardous materials or weapons are stored. In this example, the security system 100 may determine that an event has occurred when an unidentified person is present anywhere in the structure 302. The security system may also determine that an event has occurred when any person enters zone 2 304 or zone 3 306. The response of the security system 100 to the event is determined by rules established by the administrator of the security system 100. For example, where the event is the detection of an unidentified person in the structure 302, the system may issue a general alarm and take aggressive countermeasures. When the event is the detection of a person entering zones 2 or 3, the system may first determine the identity of the person and then determine whether the person is authorized to be in the zone. Rules may be compounded. For example, a rule may provide that a person who is not authorized to enter a zone may do so when accompanied by one who is. Alternatively, a person authorized to enter a zone may not be permitted to enter a zone with a person who is not authorized.

As previously described, the identity of a person may be determined using a voice recognition system. However, other means may be used by the security system 100 to identify individuals who may be present in the structure 302. By way of illustration and not by way of limitation, each individual who is authorized to be in the structure 302, or a particular zone of the structure 302, may carry a transportable alert device 115 that has been registered with the security system 100. The location of a person relative to the structure 302 may be determined using GPS or other known location systems. A person may also carry a tag, such as an RFID tag, that can be read by the security system 100. The security system 100 may also be equipped with biometric acquisition components to allow the security system 100 to acquire biometric measures to identify and authorize individuals automatically. By way of illustration and not by way of limitation, biometric measures may include a voice print, a retinal scan, and a facial scan.

The privileges of a person may be determined by the administrator of the security system 100 and stored in the control unit 104 the monitoring device 108.

The security system 100 may also be configured to monitor an area 310 outside of the structure 302. The area 310 may also be divided into zones, such as zones 4 312 and zone 5 314. As described above with respect to the structure 302, the response of the security system 100 to the detection of an event in the area 310 may be subject to rules that are zone based. In addition, the response of the security system 100 to the detection of an event in the area 310 may also depend on whether a person is present in the structure 302.

By way of illustration and not by way of limitation, zone 4 312 may be a yard and zone 5 314 may be a swimming pool. When the security system 100 detects presence of an identified person in zone 4 312, it may determine that an event has occurred. The response of the security system 100 to the event may depend on the time of day, the length of time the unidentified person is present in zone 4 100 and whether anyone is present in the structure 302. When no one is present in the structure 302, the security system 100 may take a countermeasure that is geared to deterring the unidentified person from entering the house as, for example, issuing a verbal or audible warning. However, when the structure 302 is occupied, the response may be more aggressive, including legal countermeasures that are designed to protect the occupants of the structure 302 from a possible attack.

Different rules may be applied to different zones. For example, if zone 5 314 were a swimming pool, the security system 100 may apply rules that are designed to prevent unidentified individuals and unauthorized individuals (even if identified) from entering the pool area (i.e., zone 5 314).

As previously described, the system components may be implemented using a variety of the computing devices, including a personal computer. By way of illustration, the functional components of a computing device 460 are illustrated in FIG. 4. Such a computing device 460 typically includes a processor 461 coupled to volatile memory 462 and a large capacity nonvolatile memory, such as a disk drive 463. The computing device 460 may also include a floppy disc drive 464 and a compact disc (CD) drive 465 coupled to the processor 461. Typically the computing device 460 will also include a pointing device such as a mouse 467, a user input device such as a keyboard 468 and a display 469. The computing device 460 may also include a number of connector ports 466 coupled to the processor 461 for establishing data connections or network connections or for receiving external memory devices, such as a USB or FireWire® connector sockets. In a notebook configuration, the computer housing includes the pointing device 467, keyboard 468 and the display 469 as is well known in the computer arts.

While the computing device 460 is illustrated as using a desktop form factor, the illustrated form is not meant to be limiting. For example, some or all of the components of computing device 460 may be implemented as a desktop computer, a laptop computer, a mini-computer, or a personal data assistant.

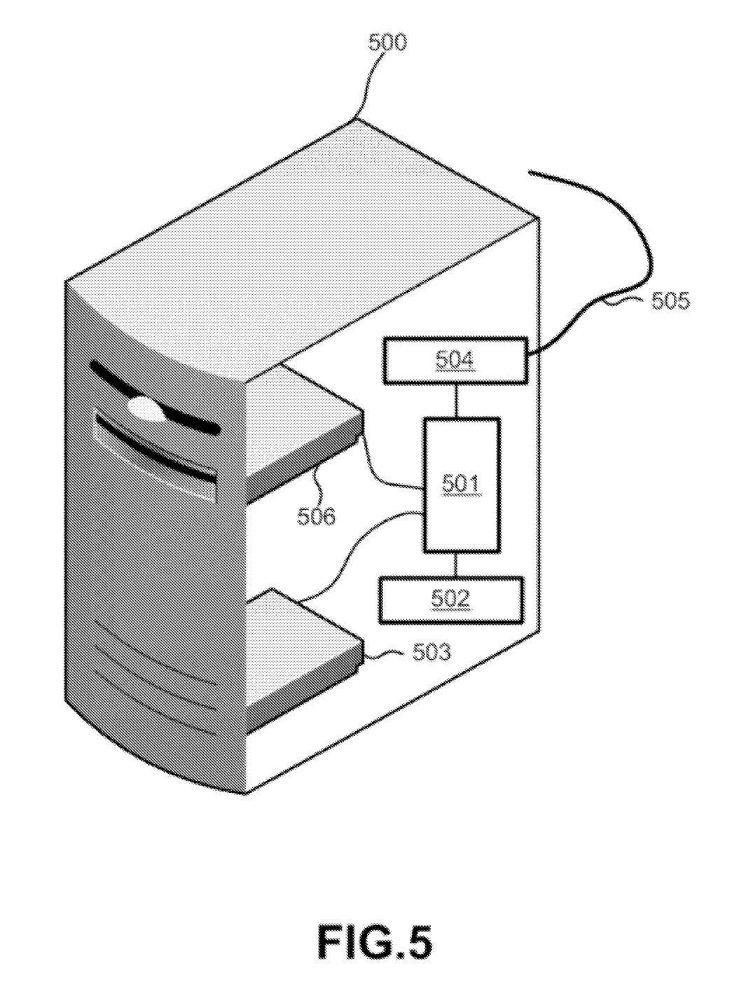

A number of the embodiments described above may also be implemented with any of a variety of computing devices, such as the server device 500 illustrated in FIG. 5. Such a server device 500 typically includes a processor 501 coupled to volatile memory 502 and a large capacity nonvolatile memory, such as a disk drive 503. The server device 500 may also include a floppy disc drive and/or a compact disc (CD) drive 506 coupled to the processor 501. The server device 500 may also include network access ports 504 coupled to the processor 501 for establishing data connections with network circuits 505 over a variety of wired and wireless networks using a variety of protocols.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A security system for monitoring a defined space comprising:
a sensor device configured to detect a sensor event;
one or more countermeasure devices;
a control unit connected to the sensor device and to the countermeasure device and configured with software instructions to cause the control unit to perform operations comprising:
receiving a detection signal from the sensor device indicative of the detection of the sensor event;
determining whether the sensor event constitutes an alert event;
selecting a countermeasure when the sensor event constitutes an alert event, wherein the selected countermeasure is appropriate to the alert event; and
sending a countermeasure signal to at least one of the one or more counter measure devices appropriate to the selected countermeasure.

2. The system of claim 1, wherein the sensor is selected from the group consisting of a motion sensor, a sensor designed to recognize a sound of broken glass, a camera, an infrared sensor, a noise detector, a microwave detector, an ultrasonic detector, a photoelectric beam sensor, a voice recognition sensor, a digital camera coupled to facial recognition software, a retinal scanner, an infrared scanner, a biometric scanner, a presence detector, and a sensor to indicate the opening of a door or a window.

3. The system of claim 1, wherein the countermeasures are selected from the group consisting of a digital voice warning, a loud noise generation system, a pepper spray dispenser, water spray, anti-personnel foam spray and a blinding light generator.

4. The system of claim 1, wherein the instruction for determining whether the sensor event constitutes an alert event comprises instructions for:
determining whether each person present within the defined space at a time when the sensor event occurs is a registered occupant; and
determining that the sensor event constitutes the alert event when at least one person present with the defined space is not a registered occupant.

5. The system of claim 4 further comprising a datastore, wherein the datastore comprises identifying information of registered occupants of the defined space, and wherein the identifying information is at least one biometric measure and wherein the instruction for determining whether each person present within the defined space at a time when the sensor event occurs is a registered occupant comprises instructions for:
acquiring a biometric measure of a person present in the defined space;
comparing the acquired biometric measure to the identifying information in the datastore; and
determining that the person within the defined space is a registered occupant when the acquired biometric measure matches the identifying information in the datastore.

6. The system of claim 5, wherein the biometric measure is selected from the group consisting of a voice print, a retinal scan, and a facial scan.

7. The system of claim 4 further comprising a datastore, wherein the datastore comprises identifying information of registered occupants of the defined space, wherein the identifying information is an identifier and wherein the instruction for determining whether each person present within the defined space at a time when the sensor event occurs is a registered occupant comprises instructions for:
requesting an identifier of a person present in the defined space;
comparing the acquired identifier to the identifying information in the datastore when the identifier is received;
determining that the person within the defined space is a registered occupant when the acquired identifier matches the identifying information in the datastore; and
determining that the person within the defined space is a not registered occupant when the acquired identifier does not match the identifying information in the datastore or when no identifier is received from the person present in the defined space.

8. The system of claim 7, wherein the identifier is selected from the group consisting of an identifier acquired from a wireless device and an identifier acquired from a radio frequency identification tag.

9. The system of claim 1, wherein the defined space is selected from the group consisting of a structure, a dwelling, a commercial building, a yard and a lot.

10. The system of claim 1, wherein the defined space is subdivided into zones and wherein the instruction for determining whether the sensor event constitutes an alert event comprises instructions for:
determining a zone in which the sensor event occurred;
acquiring a set of rules for the zone in which the sensor event occurred; and
applying the rules for the zone to determine whether the sensor event constitutes an alert event.

11. A method for monitoring a defined space comprising:
receiving a detection signal from a sensor indicative of a detection of a sensor event;
determining whether the sensor event constitutes an alert event;
selecting a countermeasure when the sensor event constitutes an alert event, wherein the selected countermeasure is appropriate to the alert event; and
sending a countermeasure signal to at least one of the one or more counter measure devices appropriate to the selected countermeasure.

12. The method of claim 11, wherein the one or more sensors are selected from the group consisting of motion sensors, sensors designed to recognize the sound of broken glass, cameras, infrared sensors, noise detectors, microwave detectors, ultrasonic detectors, photoelectric beam sensors, voice recognition sensors, a digital camera coupled to facial recognition software, a retinal scanner, an infrared scanner and biometric scanner, presence detectors, and sensors to indicate the opening of a door or window.

13. The method of claim 11, wherein the countermeasures are selected from the group consisting of a digital voice warning, a loud noise generation system, a pepper spray dispenser, water spray, anti-personnel foam spray and a blinding light generator.

14. The method of claim 11, wherein determining whether the sensor event constitutes an alert event comprises:
determining whether each person present within the defined space at a time when the sensor event occurs is a registered occupant; and
determining that the sensor event constitutes the alert event when at least one person present with the defined space is not a registered occupant.

15. The method of claim 14, wherein determining whether each person present within the defined space at a time when the sensor event occurs is a registered occupant comprises:
acquiring a biometric measure of a person present in the defined space;
comparing the acquired biometric measure to identifying information in a datastore; and
determining that the person within the defined space is a registered occupant when the acquired biometric measure matches the identifying information in the datastore.

16. The method of claim 15, wherein the biometric measure is selected from the group consisting of a voice print, a retinal scan, and a facial scan.

17. The method of claim 14, wherein determining whether each person present within the defined space at a time when the sensor event occurs is a registered occupant comprises:
requesting an identifier of a person present in the defined space;
comparing the acquired identifier to identifying information in a datastore when the identifier is received;
determining that the person within the defined space is a registered occupant when the acquired identifier matches the identifying information in the datastore; and
determining the that the person within the defined space is not a registered occupant when the acquired identifier does not matches the identifying information in the datastore or when no identifier is received from the person present in the defined space.

18. The method of claim 17, wherein the identifier is selected from the group consisting of an identifier acquired from a wireless device and an identifier acquired from a radio frequency identification tag.

19. The method of claim 11, wherein the defined space is selected from the group consisting of a structure, a dwelling, a commercial building, a yard and a lot.

20. The method of claim 11, wherein the defined space is subdivided into zones and wherein determining whether the sensor event constitutes an alert event comprises instructions for:
determining a zone in which the sensor event occurred;
acquiring a set of rules for the zone in which the sensor event occurred; and
applying the rules for the zone to determine whether the sensor event constitutes an alert event.
